(19) United States
(12) Patent Application Publication
(10) Pub. No.: US 2004/0223789 A1
(43) Pub. Date: Nov. 11, 2004

(54) Developing apparatus

(75) Inventors: Satoru Inami, Numazu-shi (JP); Takayuki Namiki, Yokohama-shi (JP); Nobuo Komiya, Odawara-shi (JP); Daisuke Baba, Mishima-shi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/787,102

(22) Filed: Feb. 27, 2004

(30) Foreign Application Priority Data
Feb. 28, 2003 (JP) 053224/2003(PAT.)
Feb. 28, 2003 (JP) 053225/2003(PAT.)

(51) Int. Cl. G03G 15/08

(52) U.S. Cl. 399/252

(57) ABSTRACT

A developing apparatus includes a developer carrying member for carrying a developer; a developer regulating member, contacted to the developer carrying member, for regulating a thickness of a layer of the developer on the developer carrying member: and a lubricant provided between the developer carrying member and the developer regulating member, wherein a charge polarity of the lubricant is opposite to a charge polarity of the developer, and a weight average particle size of the lubricant is not more than ⅓ of a weight average particle size of the developer.

### FIELD OF THE INVENTION AND RELATED ART

The present invention relates to a developing apparatus preferably employed by an electrophotographic image forming apparatus such as a copying machine, a laser beam printer, etc.

First, referring to FIG. 7, a typical electrophotographic image forming apparatus in accordance with the prior art will be described.

Generally, an image forming apparatus comprises: a rotatable photosensitive member 101 as a latent image bearing member; a charging apparatus 102 for charging the photosensitive member 101 to a predetermined potential level while being rotated by the rotation of the photosensitive member 101; an exposing apparatus 103 for forming an electrostatic latent image or, the photosensitive member 101; a developing apparatus 104 for developing the electrostatic latent image on the photosensitive member 101 into a visible image; a transferring apparatus 105 for transferring the visible image on the photosensitive member 101 onto transfer medium; a fixing apparatus 108 for fixing the visible image to the transfer medium to yield a permanent image; and a cleaning apparatus 106 for recovering the developer particles which failed to be transferred onto the transfer medium and remained on the photosensitive member 101.

In recent years, it has become a common design to integrally dispose some of the above described components of an image forming apparatus, more specifically, the photosensitive member 101, charging apparatus 102, developing apparatus 104, and cleaning apparatus 106, in a cartridge removably mountable its the main assembly or an image forming apparatus, in order to provide an image forming apparatus which is virtually free of maintenance, being therefore superior in usability.

The developing apparatus 104 comprises a minimum of: developer 111 (which hereinafter will be referred to as “toner”): a developer carrying member 110 (which hereinafter will be referred to as “development sleeve”) for carrying the toner 111; and a toner layer thickness regulating member 109 (which hereinafter will be referred to as “development blade”) for regulating a coat of toner formed on the peripheral surface of the development sleeve 110. In order to check the development sleeve 110 in quality, for example, external appearance, when the image forming apparatus shown in FIG. 7 is manufactured, generally, the development sleeve 110 is rotated, without being coated with the toner 111, for a predetermined length of time, during the manufacturing step in which the developing apparatus 104 is assembled.

During this test rotation of the development sleeve 110, the development blade 109 and development sleeve 110 sometimes sustain scratches. Further, the elastic edge portion of the development blade 109, formed of elastic material such as urethane rubber, is sometimes dragged into the contact area between the development blade 109 and development sleeve 110. If an image forming apparatus suffering from such a problem is offered on the market, it creates a problem in that as the image forming apparatus is put to use, the toner 111 is not uniformly coated on the peripheral surface of the development sleeve 110.

In order to solve this problem, the development blade 109 is coated with lubricant, on the side which is placed in contact with the peripheral surface of the development sleeve 110, in the aforementioned image forming apparatus assembly step, in which the development sleeve 110 is rotated, without being coated with the toner, for a predetermined length of time. This is a common practice.

As the lubricant to be used for this purpose, such lubricant that is proper in terms of electrical charge, particle shape, etc., is used, because there is a possibility that during the early stage of the first time usage of the developing apparatus 104, the lubricant coated on the development blade 109 will affect the properties of the development sleeve 110, sometimes effecting development streaks.

Japanese Laid-open Patent Application 8-211728, for example, proposes a method for coating a development sleeve with spherical particulates of silicone resin, the average particle diameter of which is in the range of 5-30 μm Japanese Laid-open Patent Application 11-119551 proposes a method for coating a development sleeve with spherical particulates of silicone resin (spherical particulates of PMMA, urethane, acrylic resin, polystyrene, or PVD), the average particle diameter of which is in the range of 5-45 μm, and which holds a proper amount of electrical charge, or silicone resin particulates which are nonuniform in shape and size. Further, recently, Japanese Laid-open Patent Application 2,002-278262, which is a recent application, proposes a method for coating a development sleeve with spherical polymer particulates, which are no less than 0.90 in average circularity index, and the weight average particle diameter of which is greater in value than the surface roughness Rz of the developer carrying member, by an amount of 0.23-1.4 mg/cm in terms of the lengthwise direction of the developer regulating member and developer carrying member.

However, even when a development sleeve was lubricated with such lubricant as the above described lubricant in accordance with the prior art, the problems which will be described next sometimes occurred.

That is, when a developing apparatus is brand-new, the toner particles in the developer container of the developing apparatus do not have electrical charge. Therefore, the amount of the electrical charge they will have is not likely to reach a proper amount, even if electrical charge is given to the toner particles, in the contact area between the development blade and development sleeve. Thus, a brand-new developing apparatus is sometimes unsatisfactory in performance, during the very early stage of its usage; for example, it yields an image lower in density, or an image, the lines of which are narrower.

Further, insufficient charging of toner particles sometimes results in the formation of an image suffering from a ghost, which reflects the latent image present on a photosensitive member during the preceding rotation of the development sleeve, as shown in FIG. 8.

During the early stage of lie first time usage of a developing apparatus, the portion of a latent image, which corresponds to the first rotation of the development sleeve, is developed darker, and the portions of the latent image, which correspond to the second rotation and thereafter, are developed lighter, resulting in the formation of the conspicuous negative ghost. This occurs for the following reason. That is, after the toner particles on the development sleeve are consumed for development during the first rotation of the development sleeve, not only does the development sleeve fail to be immediately coated with a proper amount of toner, but also, the toner particles on the development sleeve fail to be given a proper amount of electrical charge. Therefore the development performance of the development sleeve is lower during the second rotation, and thereafter resulting in the formation of the negative ghost, during the early stage of the first time usage of the developing apparatus.

In order to solve this problem, the performance of a brand-new developing apparatus must be at a higher level, that is, the normal level, from the very beginning of its first time usage. As a means for making a brand-new developing apparatus perform at the normal level from the very beginning of its usage, it is possible to raise the level of ease with which the toner particles are charged, in order to give the toner particles the proper amount of electrical charge. This method, however, is not desirable, because it excessively charges the toner, resulting in reduction in density, during the latter half of the toner life.

It is also possible to design an image forming apparatus so that it is detected whether or not the developing apparatus is in the early stage of its first time usage, and so that if the developing apparatus in this early stage, development bias of the main assembly of an image forming apparatus is shifted in the direction to increase the performance of the development sleeve, in order to enable the image forming apparatus to form an image with the normal density, even during this period. However, this method fails to prevent the problem that the first rotation, and the rotation thereafter become different in density. Therefore, this method is not particularly effective to prevent the formation of the negative ghost.

### SUMMARY OF THE INVENTION

The primary object of the present invention is to provide a developing apparatus stable in development density throughout its service life

Another object of the present invention is to provide a developing apparatus which does not suffer from the problem that an image substandard in density is formed during the early stage of the first time usage of the developing apparatus.

Another object or the present invention is to provide a developing apparatus which does not suffer from the problem that an image suffering from the negative ghost is formed during the early stage of the first time usage of the developing apparatus.

These and other objects, features, and advantages of the present invention will become more apparent upon consideration of the following description of the preferred embodiments of the present invention, taken in conjunction with the accompanying drawings.

### BRIEF DESCRIPTION OF THE DRAWINGS

FIG. 1 is a schematic sectional view of the contact area, and its adjacencies, between a development sleeve and a development blade.

FIG. 2 is a vertical schematic view of a typical image forming apparatus, showing the general structure thereof.

FIG. 3 is a vertical schematic view of a typical developing apparatus, showing the general structure thereof.

FIG. 4 is a schematic drawing showing a method for coating a development sleeve with lubricant.

FIG. 5 is a graph showing the relationships among the polymer particulates material, polymer particulates diameter, and reflection density.

FIG. 6 is a schematic drawing showing a method for coating a development blade with lubricant.

FIG. 7 is a schematic sectional view of a typical image forming apparatus in accordance with thee prior art, showing the general structure thereof.

FIG. 8 is a schematic drawing depicting the negative ghost.

FIG. 9 is a graph showing the relationship between the particle diameter of polymer toner and the amount by which the development sleeve is coated with the toner.

### DETAILED DESCRIPTION OF THE PREFERRED EMBODIMENTS

Hereinafter, the preferred embodiments of the present invention will be described with reference to the appended drawings.

In the case of the prior art, the type of material, inclusive of the shape of its particles, for the lubricant for lubricating a development sleeve and a development blade, is chosen within the range in which toner properties in terms of electrical charge are not affected.

Since one of the objects of the inventors of the present invention was to improve a developing apparatus in terms of the quality of the image formed curing the initial stage of its first time usage, the possibility of using the lubricant for improving a developing apparatus in these terms came to the minds of the inventors. Based on this idea, they did extensive research, arriving at the idea of raking lubricant function as micro-carrier.

More concretely, as lubricant, spherical polymer particulates are used, which are smaller in weight average particle diameter than toner, and opposite in charge polarity (triboelectric charge polarity) to toner.

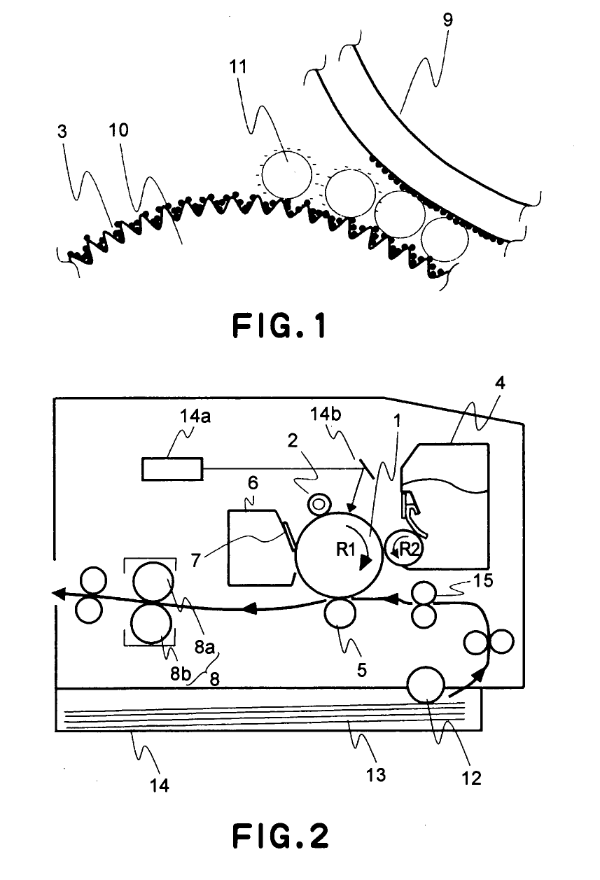

FIG. 1 is a schematic sectional view of the contact area between a development sleeve 10 and a development blade 9, and its adjacencies. In this drawing, the development blade 9 as a developer regulating member is placed in contact with the development sleeve 10 as a developer carrying member to regulate the thickness of the layer of toner 11 as developer. Also in the drawing, each of the small black round circles represents a lubricant particle 3.

During the early stage of the first time usage of this developing apparatus, the toner 11 is conveyed so that it comes into contact with the polymer particulates (lubricant) 3 on the development sleeve 10 or development blade 9. Since the polymer particulates (lubricant) 3 are opposite in charge polarity to the toner 11, they work as micro-carriers increasing thereby the amount of the electrical charge the toner 11 carries. As a result, toner 11 is given a proper amount of electrical charge even during the early stage of the first time usage of the developing apparatus therefore, an image with a substandard density, an image suffering from the negative ghost, or the like images, are not formed.

The smaller the contact area between a toner particle and a polymer particle, the smaller the effect of the polymer particle upon the amount by which the amount of electrical charge the toner particle carries is boosted, and therefore, the smaller the effectiveness of the polymer particulates in preventing the formation of an image with ac substandard density, an image suffering from the negative ghost, or the like images. Regarding polymer particle size, the greater the weight average particle diameter of polymer particulates, the greater the amount of electrical charge the polymer particulates can carry. Therefore, the usage of polymer lubricant greater in weight average particle diameter reduces the total amount of the electrical charge the combination of the toner particles and polymer particulates, as lubricant, carries, reducing substantially the performance of a developing apparatus in the aforementioned terms.

Thus, the weight average particle diameter of the polymer lubricant is desired to be substantially smaller than that of the toner. More specifically, the former is desired to be no greater than one third the latter.

Obviously, the smaller the weight average particle diameter of the polymer lubricant, the greater the number of the polymer particles which come into contact with each toner particle, and therefore, the greater the total contact area between a toner particle and the polymer lubricant particles which adhere to the toner particle, and therefore, the greater the amount of the additional electrical charge which the polymer lubricant particles give to the toner particle. Further, the smaller the weight average particle diameter of the polymer lubricant, the smaller the amount of the electrical charge each polymer lubricant particle can carry. Thus, if the weight average particle diameter of the polymer lubricant is smaller than a certain value, electrostatic adhesion of the polymer lubricant particles to the toner particles does not reduce developing apparatus in terms of development density, ghost formation, etc. In order for the polymer lubricant to be effective in the aforementioned terms, the weight average particle diameter of the polymer lubricant is desired to in the range of 0.01 μm-3 μm.

It is also important that the charge polarity of the lubricant is opposite to that of the toner. Testing various substances as the candidates for the polymer lubricant material revealed that for negative toner, that is, toner negative in inherent polarity, melamine resin was suitable as the lubricant material, whereas for positive toner, that is, toner positive in inherent polarity, fluorinated resin was suitable as the lubricant material.

In terms or the amount by which the electrical charge is gained by a toner particle due to the adhesion of polymer lubricant particles to the toner particle, a polymer lubricant the particles of which are not uniform in shape, is smaller than a polymer lubricant which is uniform in particle shape. Further, in terms of the strength of adhesion between a toner particle and a lubricant particle, the former is greater than the latter, being therefore more likely to remain adhered to the toner particle while the toner is consumed for development. Therefore, if the development sleeve or development blade is coated with the polymer lubricant which is nonuniform in particle shape, the lubricant on the development sleeve or development blade quickly disappears, along with the beneficial effect of the lubricant, that is, the prevention of the formation of an image with a substandard density, an image suffering the negative ghost, and the like images. In other words, if the polymer lubricant is not uniform in particle shape, it does not last long, nor the benefits it provides.

Thus, a polymer lubricant particle is desired to be spherical, more specifically, no less than 0.90 in circularity index. Polymer lubricant, the particles of which are greater in circularity index then 0.90 is greater in the length of time it can remain on the development sleeve and development blade to function as micro-carrier to give a toner particle an additional amount of electrical charge, while functioning as lubricant.

If the amount of the lubricant on the development sleeve or development blade is greater then a certain value, the lubricant layer becomes nonuniform in thickness. As the lubricant layer becomes nonuniform in thickness, the toner particles coated on the development sleeve or development blade, across the areas where the lubricant layer is nonuniform, become nonuniform in the amount of their electrical charge, resulting thereby in the formation of an image abnormal in toner density. Thus, the amount by which the lubricant is coated on the development sleeve or development blade is desired to be relatively small, although if it is smaller than a certain value, some areas or the development sleeve or development blade may not be sufficiently coated, or may not be coated at all, with the lubricant, which also is problematic.

In summary, when coating the development blade with lubricant in advance, the amount or the lubricant is desired to be in the range of 1.5-15 g/m², whereas when coating the development sleeve with lubricant in advance, the amount of the lubricant is desired to be in the range of 0.18-1.9 g/m². When the amount of the lubricant on the development blade or development sleeve is in the above ranges, respectively, that is, in the proper range, the formation of an image suffering from defects such as density nonunformity, vertical streaks, etc., can be prevented. The reason the development blade is to be coated with a greater amount of the lubricant than the development sleeve is that the development sleeve, which must be coated with the lubricant across the entirety of its peripheral surface, is greater in the surface area to be coated than the development blade.

As long as such polymer lubricant that is opposite in polarity to the toner is selected as the lubricant for the development sleeve or development blade, the formation of an image substandard in density, and image suffering from the negative ghost, or the like, can be prevented, regardless of toner particle shape. The effect of the polymer lubricant, however, is more conspicuous when toner possesses the following properties.

Incidentally, “lubricant polarity” means the polarity of the lubricant while the lubricant is between the development sleeve and development blade, prior to the first time usage of a developing apparatus; it does not means the polarity to which it is charged by the friction between the lubricant and toner.

That is, the above described effect of the coating of the development sleeve or development blade with the polymer lubricant is greatest when toner satisfies the following requirement:

no less than 3 μm in the particle size equivalent to the diameter of a circle;

no less than 90% t in number basis cumulative value of toner particles which are no less than 0.900 in circularity index; and

Y>exp 5.51×X^{-0.645}

X (μm): weight average particle diameter of toner

Y (%): number basis cumulative value of toner particles which are no less than 0.950 in circularity index

(5.0<X≦12.0)

Comparing a toner particle in this embodiment as high in circularity index as described above to a toner particle in accordance with the prior art which is equal in volume to the toner particle in this embodiment, but is lower in circularity index, the former is different from the latter in surface area size. Therefore, the former is smaller in the amount of electrical charge it can carry than the latter. Thus, the toner in this embodiment, which is as high in circularity index as described above, has a weakness in that it is likely to have a broader electrical charge distribution, being likely to yield a very conspicuous negative ghost, in particular, in the early stage of the first time usage of a developing apparatus.

This weakness of the toner higher in circularity index, that is, the generation of the negative ghost, can be overcome by choosing the lubricant in this embodiment, which matches the higher circularity index of the toner, as the lubricant for the development sleeve or development blade, in order to obtain an image of excellent quality.

As described above, in this embodiment, lubricant capable of functioning as micro-carrier is employed. Therefore, the problem that an image substandard in density, an image suffering from the negative ghost, or the like images, are formed in the early stage of the first time usage of a developing apparatus, or a process cartridge comprising a developing apparatus, does not occur in other words, a developing apparatus in this embodiment which employs the lubricant in this embodiment remains stable, in terms of the toner density, throughout its service like.

(Embodiment 1)

Neat, the first embodiment or the present invention will be described with reference to the appended drawings.

FIG. 2 shows an image forming apparatus equipped with the developing apparatus 4 in this embodiment. FIG. 2 is a vertical sectional view of the image forming apparatus, showing the general structure thereof.

The image forming apparatus in the drawing a comprises the main assembly as a printer engine (which hereinafter will be referred to as apparatus main assembly).

There is an electrophotographic photosensitive member 1 (which hereinafter will be referred to as “photosensitive drum”) as an image bearing member, in the apparatus slain assembly. The photosensitive drum 1 is rotationally driven around an axle, by the driving force transmitted thereto, in the direction indicated by an arrow mark R1 in the drawing, at a predetermined process speed (peripheral velocity).

As the photosensitive drum 1 is rotationally driven, its peripheral surface is charged by a charge roller 2 as a charging apparatus. The charge roller 2 is disposed so that its peripheral surface is placed in contact with the peripheral surface of the photosensitive drum 1, and is rotated by the rotation of the photosensitive drum 1 as the photosensitive drum 1 is rotated in the arrow R1 direction. To the charge roller 2, charge bias, for example, a combination of alternating current voltage and direct current voltage, is applied by a charge bias application power source (unshown). As a result, the peripheral surface of the photosensitive drum 1 is uniformly charged to predetermined polarity and potential level.

After the peripheral surface of the photosensitive drum 1 is charged, an electrostatic latent image is formed on the peripheral surface of the photosensitive drum 1 by an exposing apparatus, which comprises a laser scanner 14a, a polygon mirror (unshown), a refection levels 14b, etc. The exposing apparatus emits a beam of laser light modulated with image formation data, across the charged area of the peripheral surface of the photosensitive drum 1, selectively removing thereby electrical charge from numerous points on the charged area of the photosensitive drum 1. As a result, an electrostatic latent image is formed on the peripheral surface of the photosensitive drum 1.

After being formed on the peripheral surface of the photosensitive drum 1 through the above described process, the electrostatic latent image is developed by the developing apparatus 4; toner particles are adhered to the electrostatic latent image, creating an image formed of toner. The developing apparatus 4 will be described later in detail.

The toner image on the peripheral surface of the photosensitive drum 1 is transferred by a transfer roller 5 as a transferring apparatus, onto a transfer medium 13, which had been stored in a sheet feeder cassette 14, and has been delivered to the transfer nip, in synchronism with the formation of the toner image on the photosensitive drum 1, after being conveyed in the direction indicated by an arrow mark P, by a pickup roller 12, a pair of registration rollers 15, etc. To the transfer roller 5, transfer bias, which is opposite in polarity to the toner image on the photosensitive drum 1, is applied from a transfer bias application power source (unshown), whereby the toner image on the photosensitive drum 1 is transferred onto the recording medium 13.

After the toner particles remaining on the photosensitive drum 1 after the transfer of the toner image onto the transfer medium 13 are removed by the cleaning blade 7 of a cleaning apparatus 6, the photosensitive drum 1 is used for the formation of the next image.

Meanwhile, the transfer medium 13, onto which the toner image has just been transferred, is conveyed to a fixing apparatus 8, in which the toner image oh the transfer medium 13 is fixed by being subjected to the heat and pressure from the fixation roller 8a and pressure roller 3b of the fixing apparatus.

After the fixation of the toner image, the transfer medium 13 is discharged from the main assembly, ending the image formation sequence for forming a single copy.

Among the above described various components to carrying out an image formation process, the photosensitive drum 1, charge roller 2, developing apparatus 4, and cleaning apparatus 6, are integrated in the form of a process cartridge, which is removably mountable in the main assembly of the image forming apparatus. Incidentally, a process cartridge comprises the photosensitive drum 1, and at least one among the charge roller 2, developing apparatus 4 and cleaning apparatus 6. Further, the developing apparatus 4 alone may be placed in a cartridge removably mountable in the main assembly of an image forming apparatus.

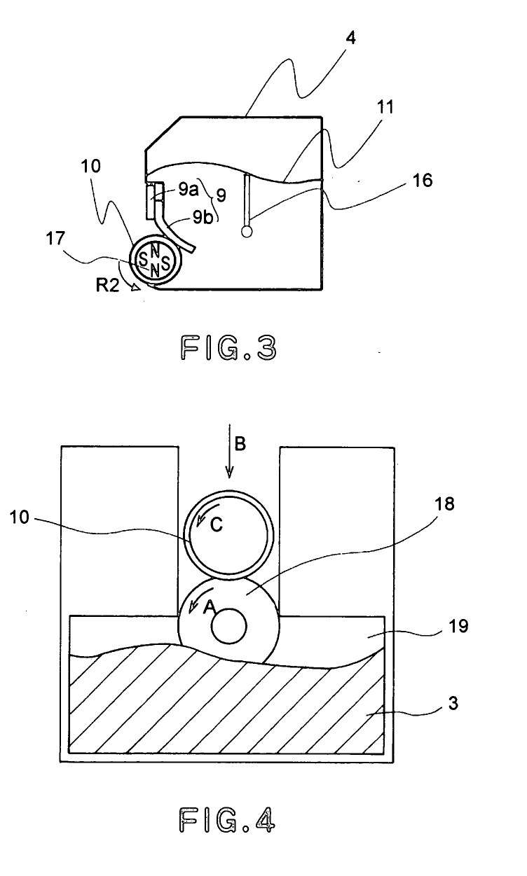

Next, referring to FIG. 3, the developing apparatus 4 in this embodiment will be described in detail. FIG. 4 is a vertical sectional view of the developing apparatus 4, showing the general structure thereof.

The developing apparatus 4 shown in this drawing is such a developing apparatus that uses magnetic single-component toner as developer. It essentially comprises: a toner container for storing the toner 11; a stirring member 16 for conveying the toner 11 in the toner container 1 while loosening it; a development sleeve 10 as a developer carrying member for bearing and conveying the toner 11 having arrived at the development roller 10; and a development blade 9 as a developer regulating stabber for regulating the thickness of the toner layer on the development sleeve 10.

The development sleeve 10 is a piece of nonmagnetic cylindrical pipe formed of aluminum, stainless steel, or the like. It is supported by the toner container, being enabled to be rotated in the direction indicated by an arrow mark R2. In this embodiment, a piece of hollow cylindrical tube of aluminum with a diameter of 16.0 mm is used as the development sleeve 10.

The development sleeve 10 is provided with a pair of rings (unshown) fitted around the lengthwise (axial) end portions of the development sleeve 10, one for one. The development sleeve 10 is positioned so that the peripheral surface of each ring is placed in contact with the peripheral surface of the photosensitive drum 1, maintaining a predetermined distance (gap) between the two peripheral surfaces.

In order to assure that the toner particles on the development sleeve 10 will have a proper amount of electrical charge before they will be used for development, the peripheral surface of the development sleeve 10 is coated with solution of phenol resin, in which carbon particles, charge control agent, and particulates for making the peripheral surface of the development sleeve 10 rougher in texture, have been dispersed.

Within the hollow of the development sleeve 10, a magnet 17 is disposed, which is cylindrical and comprises a plurality of N and S magnetic poles alternately positioned in the circumferential direction. Unlike the development sleeve 10 which is supported so that it can be rotated in the direction of the arrow R2, the magnet 17 is stationarily disposed in the hollow of the development sleeve 10.

The development blade 9 comprises art elastic blade 9b, and a metallic plate 9a as the support for the elastic blade 9b. The development blade 9 is disposed so that the elastic blade 9b touches the peripheral surface of the development sleeve 10

The elastic blade 9b is a piece of plate formed of urethane. It is attached to the metallic support plate 9a by the base portion, and its free edge portion is kept pressed upon the peripheral surface of the development sleeve 10 with the application of a predetermined amount of pressure, being thereby kept elastically deformed. The elastic blade 9b is for regulating the thickness of the layer of the toner attracted onto the peripheral surface of the develop sleeve 10 by the aforementioned magnet 17. In this embodiment, the thickness of the elastic blade 9b is 1.0 mm, and the contact pressure between the development blade 9b and development sleeve 10 in terms Or linear pressure is set to 29.4 N/m.

After being borne on the peripheral surface of the development sleeve 10, the toner particles are conveyed in the rotational direction of the development sleeve 10 indicated by the arrow mark R2, to the development station in which they are positioned virtually in contact with the peripheral surface of the photosensitive drum 1. While they are conveyed to the development station, they are given a proper amount of electrical charge by the friction which occurs among them as they are conveyed, and the friction which occurs between the toner particles and development sleeve 10, or between the toner particles and elastic blade 9b.

To the development sleeve 10, development bias, which is a combination of alternating current voltage and direct current voltage is applied from a development bias application power source, which is an AC power source, and a development bias power source, which is a DC power source, through a sliding contact. With the application of this development bias, the toner particles on the development sleeve 10 are made to jump onto the photosensitive drum 1 and electrostatically adhere to the electrostatic latent image on the photosensitive drum 1, developing the latent image into a visible image formed of the toner particles.

Next, referring to FIG. 4, a method for is coating in advance the development sleeve 10 with lubricant in the form of powder will be described. In this embodiment, a sponge roller is first covered with the lubricant (polymer particulates), and then, the sponge roller covered with the lubricant is placed in contact with the development sleeve 10 to coat the developer sleeve with the lubricant.

A lubricant coating apparatus comprises a lubricant container 19 for storing lubricant 3, and a sponge roller 18 for coating the development sleeve 10 with the lubricant 3 in the lubricant container 19. In this embodiment, Like sponge roller 18 is formed of polyurethane which is roughly 360 μm in average pore diameter.

When coating the development sleeve 10 with the use of the sponge roller 18, the development sleeve 10 is to be positioned in the lubricant coating apparatus, in parallel to the sponge roller 18. When placing the development sleeve 10 in to the lubricant coating apparatus, it should be pushed in the direction indicated by an arrow mark B so that the peripheral surface of the development sleeve 10 will compress the sponge roller 18 by roughly 1 mm. Also when placing the development sleeve 10 into the lubricant coating apparatus, the development sleeve 10 is desired to be pressed by the lengthwise ends, with the use of a pair of rotational bearings (unshown) so that the amount by which the development sleeve 10 compresses the sponge roller 18 becomes uniform in terms of the lengthwise direction of the development sleeve 10.

The sponge roller 18 and development sleeve 10 are rotated so that their peripheral surfaces move in the opposite directions relative to each other, as shown in the drawing, so that the lubricant 3 on the sponge roller 18 is rubbed onto the development sleeve 10.

The amount by which the lubricant 3 is coated on the development sleeve 10 is determined by the depth by which the sponge roller 18 is compressed by the development sleeve 10, the peripheral velocity of the development sleeve 10 relative to the peripheral surface of the sponge roller 18, and the absolute amount of the lubricant in the lubricant container 19. In this embodiment, the development sleeve 10 is coated across the entirety of its peripheral surface, and the amount by which it is coated with the lubricant 3 is 0.6 g/m². Incidentally, the amount of the lubricant 3 on the development sleeve 10 can be substantially reduced by transferring the lubricant 3 onto a drum by applying bias to the development sleeve 10 when rotating the development sleeve 10, in the subsequent assembly step. As will be evident from the above description, by coating the development sleeve with the lubricant 3 as described above, it is possible to place the lubricant between the development sleeve 10 and development blade 9 prior to the first time usage of the developing apparatus. It should be noted here that the portion of the developing apparatus, which contains the developing means, is desired to be kept sealed from the toner container portion until the developing apparatus is used for the first time, in order to prevent the toner from reaching the development sleeve 10 prior to the first time usage of the developing apparatus. Such a seal has only to be removed when the developing apparatus is used for the first time.

At this time, the definitions of the shape of the polymer particulates as the lubricant 3, and the definition of the average particle diameter thereof, in this specification will be described.

<Shape>

In this specification, a polymer particle which is no less than 0.90 in circularity index is considered as a spherical particle, and a polymer particle which is no more than 0.90 in circularity index is considered as a non-spherical particle. Circularity index is an index for indicating the degree of surface irregularity of a particle. For example, the circularity index of a perfectly spherical particle is 1.00, and the more complex the contour of a particle, the smaller the value of this index. The circularity index is defined by the following formula:

(Circularity index)=circumference of circle equal in size to projection of particle)/(circumference of projection of particle) (1)

Circularity index is used as a simple means for quantitatively describing the shape of a particle. In this embodiment, it is obtained from the measurements of a particle obtained with the use of a measuring apparatus, more specifically, a flow type particle image analyzer FPIA-1000 (product of Toa Iyo Denshi Co.), and the above formula (1).

The circularity index is an index indicating the degree of complexity in the shape of a particle. When a particle has a perfect spherical shape, the circularity index is 1.000, and the more complex the surface in terms of shape, the smaller the circularity index. As for the actual measuring method, first, 100-150 ml of pure water is placed in a container from which impurities have been removed. Then, surfactant as dispersant, preferably, alkylbenzene sulfonate, is added to the water by 0.1-0.5 ml. Then, 0.1-0.5 g of test sample is added to the solution. Next, the suspension in which the test sample has been dispersed is subjected to ultrasonic waves (50 kHz, 120 W) for one to three minutes, attaining a dispersion density of 12,000-20,000 particles/μl. Then, the distribution of the particle sizes, equivalent to the diameter of a circle, which are no less than 0.60 μm and no snore than 159.21 μm, is obtained with the use of the aforementioned flow type particle image measuring apparatus. Incidentally, the particle density of the solution is made to fall within the range of 12,000-20,000 particles/μl, in order to keep the apparatus accurate. The measuring method is as follows.

The solution in which a test sample has been dispersed is to be flowed through the passage (which gradually widens toward the downstream end) of a flat flow cell (roughly 200 μm in thickness). A strobe and a CCD camera are positioned so that they face each other across the flow cell. In order to capture the images of the particles flowing through the flow cell, the strobe is fired at a rate of 1/30 sec, so that each particle can be photographed as a two dimensional image having a certain width in terms of the direction parallel to the direction in which the suspension is flowed through the flow cell. Then, based on the area size of the two dimensional image of each particle, the diameter of such a circle that is equal in area size to the two dimensional image of the particle is calculated. Then, the circularity index for the particle is calculated from the circumference of the projection (two dimensional image) of the particle, and size of the projection (two dimensional image) of the particle, equivalent to the diameter of a circle, using the above formula.

The reason only the particles which are no less than 3 μm in two dimensional size are used for calculating the circularity index is as follows. That is, a particle no more than 3 μm in size is treated as a particle high in circularity index by the aforementioned measuring device, making it difficult to accurately compare the particles in terms of circularity index. Thus, only the particles no less than 3 μm in size are used to calculate the circularity index of the toner, and the value obtained by the calculation is used as the circularity index of the toner.

<Weight Average Particle Diameter>

The following is the definition of the weight average particle diameter of the polymer particulates in this embodiment:

Weight average particle diameter=Σ(di×fi)/Σfi

di: particle size equivalent to the diameter of a circle

fi: total weight of particulates, the size of which equivalent to the diameter of a circle, are in the range of di−di+1.

Incidentally, all of the values substituted for the above parameters are measured with the use of a flow type particle image analyzing apparatus FPIA-1000 (product of to a Gosei Iyo Denshi Co., ltd.)

In this embodiment, the combination of magnetic single-component negative toner with a weight average particle diameter of 7 μm and the particulates of silica or the like externally added to the toner, was used as developer. As the (material for the polymer particulates as the lubricant 3, two kinds of melamine resin particulates opposite in polarity were used, which are 0.1 μm and 1 μm, respectively, in weigh average particle diameter.

For comparison, two kinds of silicone resin particulates, which were the same in polarity as the toner, were used as the polymer particulates, or the polymer lubricant 3. The weigh average particle diameters of the two kinds of the silicone resin particulates were 1 μm and 12 μm, respectively.

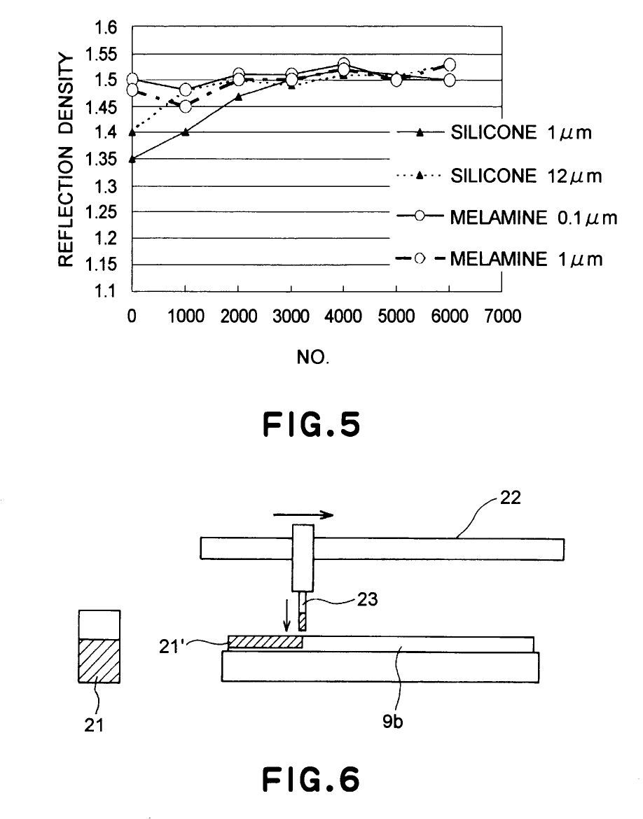

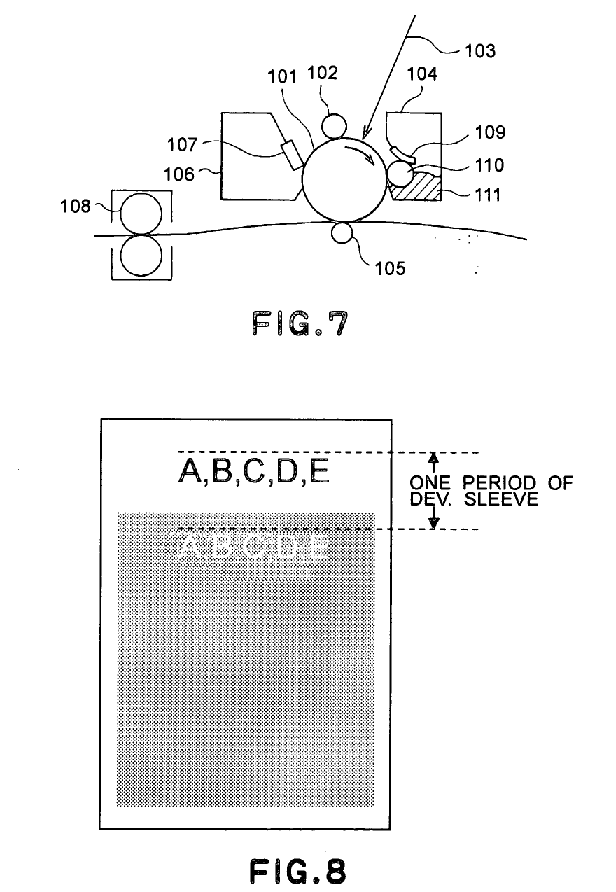

Shown in FIG. 5 and Table 1 are the results, regarding the density and negative ghost, of the experiment carried out to test the aforementioned various polymer particulates as lubricant.

TABLE 1

| | |
|---|---|
| Silicone | Melamine |

| No. | 1 μm | 12 μm | 0.1 μm | 1 μm |
|---|---|---|---|---|
| 0 | P | P | G | G |
| 1000 | NG | NG | F | F |
| 2000 | F | P | G | F |
| 3000 | G | F | G | F |
| 4000 | G | G | G | G |
| 5000 | G | G | G | G |
| 6000 | G | G | G | G |

G: Good
F: Fair
P: Poor
NG: No good

In this experiment, a plurality of copies were continuously produced using a developing apparatus capable of continuously processing 6,000 sheets of A4 size recording paper at a print ratio of 6%, in an environment in which the temperature was 15° C., at which the negative ghost was likely to appear. The printed image comprised three distinctive areas: leading end area having letters and 25 mm black squares; interval area, the dimension of which in terms of the recording paper conveyance direction, was equal to the circumference of the development sleeve (single rotation of development sleeve), and halftone trailing end area with a dot ratio of roughly 40%. The images were evaluated in terms of the conspicuousness or the negative ghost in the halftone area.

The conspicuousness of the negative ghost was evaluated in four level. In Table 1, NG means; the negative ghost was very conspicuous; P means the negative ghost was noticeable at first glance, and therefore, was intolerable; F means the negative ghost was present, but inconspicuous, being therefore tolerable; and G means no ghost occurred.

As will be evident from the graphs in FIG. 5 and Table 1, in the case of silicone resin particulates which are the same in polarity as the toner, the density was substandard and the negative ghost was very conspicuous, regardless of particle diameter of the silicone resin particulates, during the early stage of the first usage of the developing apparatus. However, the density and negative ghost improved in proportion to the cumulative number of recording paper passed through the developing apparatus.

In comparison, in the case of the melamine resin particulates in accordance with the present invention, the density was generally on the higher side relative to that of the silicone resin particulates, and image quality was much better, in particular, in terms of the negative ghost. Both the melamine particulates with a particle diameter of 0.1 μm and the melamine particulates with a particle diameter of 1 μm, in particular, the former, proved to be effective for the substandard density and negative ghost, suggesting that the smaller the particle diameter the better as the micro-carrier the melamine particulates.

When such polymer particulates that are opposite in polarity to the toner are chosen as the lubricant 3, not only does the lubricant lubricate, but also it provides the toner with an additional amount of electrical charge, stabilizing the toner in terms of the amount of electrical charge. Although this embodiment was described with reference to the negative toner, the effects similar to those obtained with the use of the negative toner can also be obtained with the use of a combination of positive toner, and polymer particulars opposite in polarity to the positive toner. It became evident from the experiment that when the positive toner was used, fluorinate resin particulates were very effective as the lubricant.

Further, when the toner was placed between the development sleeve and development blade without placing the polymer particulates between the development sleeve and development blade, the toner was not effective as lubricant, and the problem that the density level which the developing apparatus can achieve during the early stage of its first time usage is substandard, could not be solved.

As described above, the problem that an image substandard in density, an image suffering from the negative ghost, or the like images, are likely to be produced during the early stage of the first time usage of a developing apparatus could be eliminated by using, as lubricant, spherical polymer particulates which were opposite in polarity to the toner, and the particle size of which was substantially smaller than the weight average particle diameter of the toner, more specifically, no more than one third the weight average particle diameter of the toner.

(Embodiment 2)

This embodiment relates to a more reliable method for coating lubricant.

Polymer particulates which are extremely small in particle diameter easily agglomerate, making it difficult to satisfactorily coat the development sleeve or development blade therewith with consistency. If the development blade or development sleeve fails to be uniformly coated in terms of their lengthwise direction, in other words, the lubricant layer on the development sleeve or development blade is nonuniform in thickness, the toner particles in the area nonuniform in the thickness of the lubricant become nonuniform in electrical charge. Therefore, it is easier for density nonuniformity to occur. This type of density nonuniformity is likely to keep on occurring until the lubricant on both the development blade and development sleeve is completely consumed. Thus, in order to improve a developing apparatus in terms of the image quality in the early stage of its first time usage, the development sleeve and/or development blade must be uniformly coated with the lubricant.

The method in this embodiment for coating the development sleeve and/or development blade with the lubricant is such a method that is used for coating the development sleeve and/or development blade with a smallish amount of lubricant which it a combination of solvent and polymer particulates dispersed therein.

In this embodiment, the development blade 9 is coated with spherical polymer particulates as lubricant, before the development blade 9 becomes coated with toner, during the assembly of the developing apparatus 4. The lubricant is coated on the elastic blade 9b of the development blade 9, at least across the area which will be in contact with the development sleeve 10.

The lubricant may be coated on the development sleeve 10 instead of the development blade 9. However, when the lubricant is coated on the development sleeve 10, it should be coated at least across the area which comes into contact with the development blade 9 as the development sleeve 10 is placed in contact with the development blade for the first time.

Next, referring to FIG. 6, the method in this embodiment for coating the development blade 9 with the lubricant will be described. FIG. 6 is a schematic drawing showing the method for coating the elastic blade 9b with the lubricant. The hatched areas in the drawing represent the areas coated with the lubricant.

First, the lubricant (spherical polymer particulates) are mixed (dispersed) into volatile solvent. The ratio of the lubricant relative to the solvent is 2.5 parts to 11 in mass:(lubricant):(PF5060):(IPE)=2.5:4:11. PF5060 is Fluorinate. IPE stands for isopropylether.

The above described solution 21, containing the lubricant, in a container, is suctioned into the nozzle 23 of a coating device 22 movable vertically as well as horizontally, as shown in FIG. 6. The elastic blade 9b is to be immovably held, and the coating device 22 is moved to a location at which the nozzle 23 is pointed at the point of the elastic blade 9b, from which coating is to be started. Then, the coating device 22 is moved so that the nozzle 23 moves from the location corresponding to the coating starting point of the elastic blade 9b to the location corresponding to the coating ending point of the elastic blade 9b, while ejecting the solution containing the lubricant, coating thereby the elastic blade 9b with the solution (hatched area designated by referential number 21′ is coated area).

The polymer particulates used as the lubricant in this embodiment easily agglomerate. Therefore, the solution containing the polymer particulates (lubricant) is desired to be continuously stirred to keep the polymer particulates evenly dispersed, during the coating.

The aforementioned ratio is only an example of the ratio of the spherical polymer particulates relative to the solvent into which they were dispersed. The amount by which the development blade 9 is coated with the solution is desired to be adjusted in accordance with the polymer particulates content or the solution, so that the amount of the lubricant on the development blade 9 will fall in the range of 1.5-15 g/m² after the evaporation of the solvent. As long as the amount of the lubricant on the development blade 9 remains within this range, the density irregularity does not occur, and the lubricant can satisfactorily prevent the formation of an image substandard in density, an image suffering from the negative ghost, and the like images.

With the use of the above described method, the development blade 9 can be evenly coated with the lubricant. Thus, as the development sleeve 10 is attached after the development blade 9, the lubricant is uniformly coated on the development sleeve 10 in terms of the lengthwise direction of the development sleeve 10; in other words, the lubricant is placed between the development sleeve 10 and development blade 9 before the first time usage of the developing apparatus.

When a plurality of copies having the same test pattern as that used in the experiment carried out to test the first embodiment were printed using the developing apparatus (process cartridge) comprising the development blade 9 manufactured using the above described coating method, excellent results were obtained; neither vertical streaks (belts) nor density irregularity occurred. Further, this embodiment (development blade 9) was just as effective as the first embodiment (development sleeve 10) to prevent the occurrence of the density irregularity and the formation of the negative ghost.

(Embodiment 3)

This embodiment relates to the relationship between the degree of circularity of toner and the occurrence of the density irregularity and negative ghost. The following experiment carried out using a plurality of toners different in circularity index confirmed that the higher the toner in circularity index, the less likely the occurrence of the density irregularity and negative ghost.

In this embodiment, such toner that satisfies the following requirement was used:

no less than 3 μm in particle size equivalent to the diameter of a circle;

no less than 90% in number basis cumulative value of toner particles which are no less than 0.900 in circularity index; and

Y>exp 5.51×X^{-0.645}

X (μm): weight average particle diameter of toner

Y (%): number basis cumulative value of toner particles which are no less than 0.950 in circularity index

(5.0<X≦12.0).

Toner such as the above described one, in which the percentage of toner particles high in circularity index is high is superior in development performance to toner in which it is not. Thus, when toner such as the above described toner is used while properly controlling the image formation process, a high quality image is formed. Thus, toner in which the percentage of toner particles high in circularity index is high is thought to have promising prospects.

However, a toner particle which is as described above in shape also has a problem that is, during the early stage of the first time usage of a developing apparatus, such a toner particle carries no electrical charge, unlike a toner particle in accordance with the prior art, which is low in circularity index. Thus, being frictionally charged only once by the development blade or development sleeve is not enough for the toner particle to be charged to a predetermined potential level, resulting sometimes in the formation of a very conspicuous negative ghost.

In this embodiment, as examples of negative toner with a weight average particle diameter of 7 μm, toners A and B, which are styrene resin toner and polyester resin toner, respectively, are used.

When the weight average particle diameter of toner is 7 μm, exp 5.51×X^{-0.645}=70.4. Table 2 gives the results of the evaluations of four different toners: toner A in which Y=75-78 t, toner A in which Y=60-62%, toner B in which Y=75-78%, and toner B in which Y=60-62′ and B.

The experiment carried out to test this embodiment was similar to the test carried out to the first embodiment. That is, a plurality of copies were continuously produced using a developing apparatus capable of continuously processing 6,000 sheets of A4 size recording paper at a print ratio of 6%, in an environment in which the temperature was 15° C., at which the negative ghost was likely to appear. The printed image comprised three distinctive areas: leading end area having letters and 25 mm black squares; interval area, the dimension of which in terms of the recording paper conveyance direction, was equal to the circumference of the development sleeve (single rotation of development sleeve); and halftone trailing end area with a dot ratio of roughly 40%. The images were evaluated in terms of the conspicuousness of the negative ghost in the halftone area.

The standard for the evaluation of the negative ghost in this experiment was the same as that in the first embodiment.

When the lubricant was not used (Table 2), the developing apparatus used with the toners, in which Y<70.4%, continuously produced images suffering from an intolerable negative ghost from the very beginning of its first time usage up to the 1,000th copy, whereas the developing apparatus used with the toners, in which Y≧70.4%, continuously produced images suffering from a very conspicuous negative ghost up to roughly the 2,000th copy.

TABLE 2

| | |
|---|---|
| A toner | B toner |

| No. | Y = 60 | Y = 75 | Y = 62 | Y = 78 |
|---|---|---|---|---|
| 0 | P | NG | P | NG |
| 1000 | P | P | P | NG |
| 2000 | G | F | F | P |
| 3000 | G | F | G | F |
| 4000 | G | F | G | F |
| 5000 | G | G | G | G |
| 6000 | G | G | G | G |

G: Good
F: Fair
P: Poor
NG: No good

Table 3 given below shows the results of the same experiment as the above described experiments, except that the development sleeve or development blade coated with melamine particulates, as lubricant, with a weight average particle diameter of 0.1 μm was employed. The method for applying the lubricant was the same as the one in the second embodiment, and the applied amount of the lubricant was 3.0 g/m².

TABLE 3

| | |
|---|---|
| A toner | B toner |

| No. | Y = 60 | Y = 75 | Y = 62 | Y = 78 |
|---|---|---|---|---|
| 0 | G | G | G | G |
| 1000 | G | F | G | F |
| 2000 | G | G | F | F |
| 3000 | G | G | G | F |
| 4000 | G | G | G | G |
| 5000 | G | G | G | G |
| 6000 | G | G | G | G |

G: Good
F: Fair
P: Poor
NG: No good

As will be evident from Table 3, when the lubricant was used, virtually no negative ghost was formed, not only with the toners lower in circularity index (Y<70.4%), but also with the toners higher in circularity index (Y≧70.4%), from the very beginning of the first time usage of the developing apparatus till the end of its service life; the developing apparatus always formed excellent images.

After the developing apparatus was put to use for the first time, the polymer particulars as lubricant gradually transferred onto the photosensitive drum, gradually reducing thereby the amount of the lubricant on the development sleeve, and the amount of the lubricant in the contact area between the development sleeve and development blade. In other words, the polymer particulates effective for preventing the formation of the negative ghost virtually disappears from the peripheral surface of the development sleeve between roughly the 1,000th copy to the 3,000th copy. However, by the Lime the 1,000th copy to the 3,000th copy are produced, the toner particles themselves will have been give a certain amount of electrical charge during the early stage of the first time usage of the developing apparatus. Therefore, such a negative ghost that is conspicuous to a user will not be formed.

As described above, when toner high in circularity index is used by a developing apparatus comprising a development sleeve or development blade coated with polymer particulates as lubricant, the role or the lubricant as micro-carrier is enhanced. Therefore, a high quality image can be obtained, and the negative ghost, which has long been a problem, is not formed.

The selections regarding the polymer particulates and development sleeve are to be made so that the particle diameter of the polymer particulates will be smaller than the arithmetic average roughness Ra (μm) the peripheral surface of the development sleeve. Next, this relationship between the particle diameter of the polymer particulate as lubricant and the arithmetic average roughness Ra of the development sleeve will be described.

As the polymer particulates as the lubricant 3 are applied on the peripheral surface of the development sleeve 10 before a developing apparatus is used for the first time, the polymer particulates settle into the grooves in the peripheral surface of the development sleeve 10, as shown in FIG. 1, reducing thereby the apparent arithmetic average roughness Ra of the peripheral surface of the development sleeve 10.

As the value of Ra becomes smaller, not only is the amount by which the toner is borne on the development sleeve 10 reduced, but also the difference between the amount or the toner on the development sleeve 10 during the first rotation (preceding rotation) of the development sleeve 10 and that during the second rotation (following rotation) of the development sleeve 10 becomes smaller, reducing thereby the cause of the formation of the negative ghost, that is, the difference in development performance between the first and second rotations of the development sleeve 10. Therefore, the negative ghost is less likely to be formed during the early stage of the first time usage of the developing apparatus.

With the provision of the above described arrangement, as a plurality of sheets of recording paper are passed through the developing apparatus, the polymer particulates having settled into the grooves of the peripheral surface of the development sleeve are gradually consumed, gradually increasing the value of Ra on the other hand, as a plurality of sheets of recording paper are passed through the developing apparatus, in other words, as the developing apparatus increases in cumulative usage, the peripheral surface of the development sleeve is gradually worn, becoming therefore gradually smaller in the value of Ra. The amount of this decrease in the Ra value cancels the amount of the increase in the Ra value attributable to the polymer particulates consumption. Therefore, the surface roughness Ra of the peripheral surface of the development sleeve, inclusive of the polymer particulates in the groove of the peripheral surface of the development sleeve, does not change much between the very beginning of the first time usage of the developing apparatus and the end of the service life thereof. Therefore, the amount of the toner on the peripheral surface of the development roller remains stable, stabilizing thereby the level of density at which an image is formed, throughout the service life of the development sleeve (developing apparatus).

The above described arrangement is particularly effective when the weight average particle diameter of the polymer particulates is in the range of 0.01 μm-1.5 μm.

In order to assure that as toner is borne on the peripheral surface of the development sleeve by a desired amount, and the toner particles will be given a proper amount of electrical charge, the peripheral surface of the development sleeve was coated with a mixture of phenol resin, carbon particles, and surface roughening particulates (5 μm in particle diameter) for adjusting the surface roughness of the development sleeve; the peripheral surface of the development sleeve was spray coated with the solution containing the above listed ingredients. The resultant arithmetic roughness Ra of the peripheral surface of the development sleeve was 0.8 μm.

The arithmetic toughness Ra, defined in JIS. B0601 (2001), of the peripheral surface of the development sleeve was measured with a Surfcorder SE-3500 (Kosaka Kenkyusho Co.). The cutoff was set to 0.8 mm, and the measurement span was set to 4 mm. The feeding speed was set to 0.5 mm/sec.

As the polymer particulates, as the lubricant 3, in accordance with the present invention, melamine particulates were used, which was opposite in polarity to the toner, and the weight average particle diameter of which was 0.1 μm, being smaller than the arithmetic average roughness Ra of the peripheral surface of the development sleeve.

For comparison, a development sleeve coated with no lubricant, and a development sleeve coated with melamine particulates, the weight average particle diameter of which was 2 μm, which was greater than the arithmetic average roughness Ra of the peripheral surface of the development sleeve, were tested.

The amount by which the lubricant applied was set to roughly 0.55 g/m², and the lubricant was applied to the development sleeve.

Also in this experiment, a plurality of copies were continuously produced using a developing apparatus capable of continuously processing: 6,000 sheets of A4 size recording paper at a print ratio of 6%, in an environment in which the temperature was 15° C., at which the negative ghost was likely to appear. The printed image comprised three distinctive areas: leading end area having letters and 25 mm black squares; interval area, the dimension of which in terms of the recording paper conveyance direction, was equal to the circumference of the development sleeve; and halftone trailing end area with a dot ratio of roughly 40%. The evaluations were made in terms of the conspicuousness of the negative ghost in the halftone area.

The conspicuousness of the negative ghost was evaluated in four levels: NG means the negative ghost was very conspicuous; P means the negative ghost was noticeable at first glance, being therefore intolerable; F means the negative ghost was present, but inconspicuous, being therefore tolerable; and G means no negative ghost was formed.

In this experiment, the amount by which the toner was coated on the development sleeve was also measured.

More specifically, the amount by which the development sleeve was coated with toner immediately after the entirety of the peripheral surface of the photosensitive drum, which was charged to the potential level equal to the light potential level, was developed, was compared with the amount of the toner remaining on the development sleeve after the development sleeve was idled three rotations thereafter. The amount of the toner on the development sleeve immediately after the development corresponds to the ghost letters “A, B, C, D and E” in the halftone area in FIG. 8, and the amount of the toner on the development sleeve after the three idle rotations of the development sleeve corresponds to the portion of the halftone area other than the letter portions.

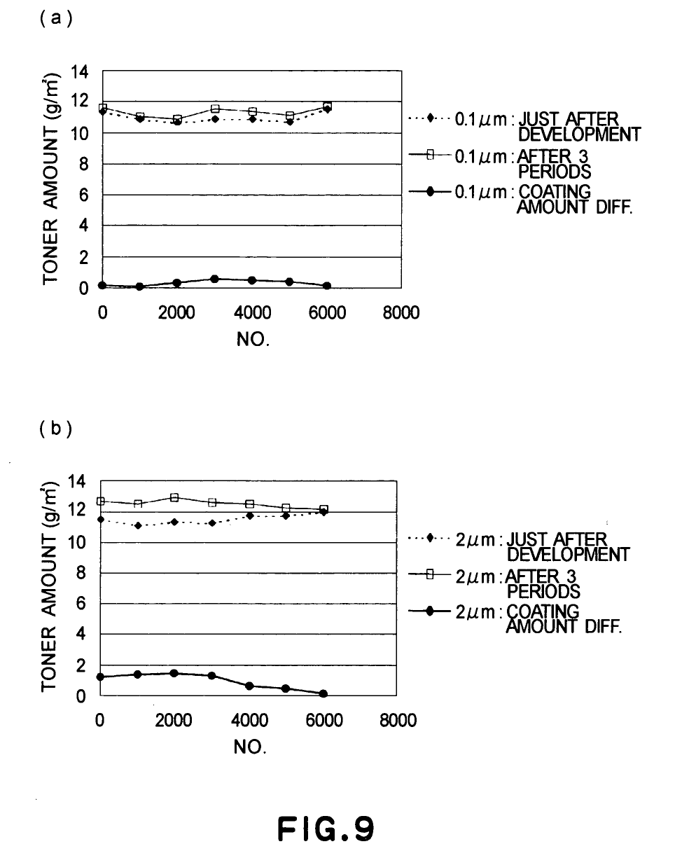

The results of the experiment are given in the form of a table (Table 4) and a graph (FIG. 9).

TABLE 4

| | |
|---|---|
| No | Melamine |

| No. | lubricant | 0.1 μm | 2 μm |
|---|---|---|---|
| 0 | NG | G | F |
| 1000 | NG | F | F |
| 2000 | P | G | F |
| 3000 | P | G | F |
| 4000 | F | G | G |
| 5000 | F | G | G |
| 6000 | G | G | G |

G: Good
F: Fair
P: Poor
NG: No good

As will be evident from Table 4, when the melamine resin particulates were used as lubricant, the formation of the negative ghost was drastically rarer than when no lubricant was used; the usage of melamine resin particulates as lubricant was effective to prevent the formation of the negative ghost. Further, in terms of the prevention of the formation of the negative ghost during the early stage of the first time usage of a developing apparatus, the melamine particulates with a particle diameter of 0.1 μm were superior to the melamine particulates with a particle diameter of 2 μm.

In terms of the amount of the toner on the development sleeve, in the case of the comparative melamine resin particulates (2 μm in particle diameter), the amount of the toner remaining on the development sleeve after the three idle rotations since the single rotation after the development was greater than the amount of the toner on the development sleeve immediately after the development, coinciding with the formation of the negative ghost, as shown in FIG. 9(b). After the printing of roughly 3,000 copies, the difference between the former and the latter gradually reduced as the cumulative number of prints increased.

In the case of the melamine particulates in accordance with the present invention (0.1 μm in particle diameter), the difference between the amount of the toner on the development sleeve immediately after the development and that after the three idle rotations thereafter was very small, virtually eliminating the formation of the negative ghost, as shown in FIG. 9(a). More over, the amount of the toner on the development sleeve remained stable throughout the entire service life of the development roller, that is, from the very beginning to end of its usage.

As will be evident from the above description, selecting, as lubricant, polymer particulate which are opposite in polarity to the toner to be used, and the weight average particle diameter of which is smaller than the arithmetic roughness Ra of the peripheral surface of the development sleeve, makes it possible to make the lubricant function not only to lubricate, but also, to provide the toner particles with a supplementary amount of electrical charge for stabilizing them in terms of the amount of electrical charge they carry, and to stabilize the amount by which the toner is coated on the peripheral surface of the development sleeve. In other words, such a selection stabilizes the performance of a developing apparatus.

The preceding embodiments were described with reference to negative tower. However, even if positive toner is used, the same effects as those described above can be obtained by using such polymer particulates opposite in polarity to the toner. When positive toner is used, fluorinate polymer resin particulates are particularly effective as lubricant. Even when positive toner is used, the particle size of polymer particulates as lubricant is desired to be selected as in the preceding embodiments.

As described above, the formation of the negative ghost which is more likely to occur during the early stage of the first time usage of a developing apparatus can be prevented by using, as lubricant, polymer particulates which are opposite in polarity to the toner used by the developing apparatus, and the relationship between the toner particle diameter of which and the arithmetic roughness Ra of the peripheral surface of the development sleeve is as described above. Moreover, the usage of the lubricant applying method in the second embodiment, and the toner, in the third embodiment, higher in circularity index, enhance the benefits of the present invention.

As described above, according to the present invention, the problem that an image substandard in density, an image suffering from the negative ghost, and the like images, are formed during the early stage of the first time usage or a developing apparatus can be eliminated. Therefore, a developing apparatus or a process cartridge remains stable in development density throughout its service life.

While the invention has been described with reference to the structures disclosed herein, it is not confined to the details set forth, and this application is intended to cover such modifications or changes as may core within the purposes of the improvements or the scope of the following claims.

What is claimed is:

1. A developing apparatus comprising:
a developer carrying member for carrying a developer;
a developer regulating member, contacted to said developer carrying member, for regulating a thickness of a layer of the developer on said developer carrying member; and
a lubricant provided between said developer carrying member and said developer regulating member,
wherein a charge polarity of said lubricant is opposite to a charge polarity of said developer, and a weight average particle size of said lubricant is not more than ⅓ of a weight average particle size of said developer.

2. An apparatus according to claim 1, wherein said lubricant comprises spherical particles having an average circularity not less than 0.90.

3. An apparatus according to claim 2, wherein said lubricant comprises polymer particle.

4. An apparatus according to claim 1, wherein a weight average particle size (μm) of said lubricant is smaller than an arithmetic average roughness Ra value (μm) of a surface of said developer carrying member.

5. An apparatus according to claim 1, wherein the charge polarity of said developer is negative, and said lubricant comprises melamine resin material particles.

6. An apparatus according to claim 1, wherein the charge polarity of said developer is positive, and said lubricant comprises fluorine resin material particles.

7. An apparatus according to claim 1, wherein said lubricant has a weight average particle size of 0.01 μm-1.5 μm.

8. An apparatus according to claim 1, wherein said lubricant has a weight average particle size of 0.01 μm-3 μm.

9. An apparatus according to claim 1, wherein a coating amount of said lubricant on said developer regulating member is 1.5 g/m²-15 g/m².

10. An apparatus according to claim 1, wherein a coating amount of said lubricant on said developer regulating member is 0.18 g/m²-1.9 g/m².

11. An apparatus according to claim 1, wherein said developer contains not less than 90%, by number base cumulative value, of particles having not less than 3 μm corresponding diameters and having not less than 0.900 circularities, and wherein a weight average particle size X of said developer, and a number base cumulative value Y (%) of the particles having not less than 0.950 circularities satisfy:
Y≧exp 5.1×X^{-0.645}
(5.0<X≦12.0).

12. An apparatus according to claim 1, wherein said developing apparatus is provided in a cartridge detachably mountable to a main assembly of an image forming apparatus.

13. A developing apparatus comprising;
a developer carrying member for carrying a developer;
a developer regulating member, contacted to said developer carrying member, for regulating a thickness of a layer of the developer on said developer carrying member; and
a lubricant provided between said developer carrying member and said developer regulating member.
wherein a charge polarity of said lubricant is opposite to a charge polarity of said developer, and a weight average particle size of said lubricant is not more than ⅓ of a weight average particle size of said developer, and wherein a weight average particle size (μm) of said lubricant is smaller than an arithmetic average roughness Ra value (μm) of a surface of said developer carrying member.

14. An apparatus according to claim 13, wherein said lubricant comprises spherical particles having an average circularity not less than 0.90.

15. An apparatus according to claim 14, wherein said lubricant comprises polymer particle.

16. An apparatus according to claim 13, wherein the charge polarity of said developer is negative, and said lubricant comprises melamine resin material particles.

17. An apparatus according to claim 13, wherein the charge polarity of said developer is positive, and said lubricant comprises fluorine resin material particles.

18. An apparatus according to claim 13, wherein said lubricant has a weight average particle size of 0.01 μm-1.5 μm.

19. An apparatus according to claim 13, wherein said lubricant has a weight average particle size of 0.01 μm-3 μm.

20. An apparatus according to claim 13, wherein a coating amount of said lubricant on said developer regulating member is 1.5 g/m²-15 g/m².

21. An apparatus according to claim 13, wherein a coating amount of said lubricant on said developer regulating member is 0.18 g/m²-1.9 g/m².

22. An apparatus according to claim 13, wherein said developer contains not less than 90%, by number base cumulative value, of particles having not less than 3 μm corresponding diameters and having not less than 0.900 circularities, and wherein a weight average particle size X of said developer, and a number base cumulative value Y (%) of the particles having not less than 0.950 circularities, satisfy:

23. An apparatus according to claim 13, wherein said developing apparatus is provided in a cartridge detachably mountable to a main assembly of an image forming apparatus.
